(19) United States
(12) Patent Application Publication
(10) Pub. No.: US 2002/0033446 A1
(43) Pub. Date: Mar. 21, 2002

(54) Neutral beam processing apparatus and method

(76) Inventors: Satoshi Ichimura, Hitachi (JP); Katsutoshi Tsuchiya, Hitachi (JP); Tadashi Sato, Mito (JP); Yoshihiko Nagamine, Hitachi (JP); Yoshiya Higuchi, Tokai (JP)

Correspondence Address: MATTINGLY, STANGER & MALUR, P.C., ATTORNEYS AT LAW, 104 EAST HUME AVENUE, ALEXANDRIA, VA, 22301, US

(21) Appl. No.: 09/805,237

(22) Filed: Mar. 14, 2001

(30) Foreign Application Priority Data
Apr. 14, 2000 (JP) 2000-113519

(51) Int. Cl. H05H 3/02

(52) U.S. Cl. 250/251

(57) ABSTRACT

A neutral beam processing apparatus and method uses a neutral beam having an enlarged diameter and an increased capacity with suppressed divergence. The charged particles of the neutral beam are removed and the variations in energy are reduced. In particular, an ion beam is led from a plasma production cell and neutralized in a neutralization cell to be converted to a neutral beam, and an object to be processed is disposed in a process cell that is irradiated with the neutral beam. A multi-aperture electrode and a permanent magnet line are used for separating charged particles from the neutral beam. By an interaction between an electron cyclotron magnetic field generated by the permanent magnet line and microwaves introduced from a waveguide, a plasma and a flat space potential is generated in the neutralization cell. The neutral beam is obtained by converting the ion beam in the flat space potential.

### BACKGROUND OF THE INVENTION

1. Field of the Invention

The present invention relates to a neutral beam processing apparatus and method and, more particularly, a neutral beam processing apparatus and method suitable for performing an etching process by irradiating an object to be processed with a neutral beam, and the like.

2. Related Background Art

One of processing apparatuses using a neutral beam is a neutral beam processing apparatus for performing a process such as etching by irradiating an object to be processed such as a substrate with a neutral beam. A conventionally known neutral beam processing apparatus of this kind is disclosed in, for example, Japanese application patent laid-open publication No. Hei 7-193047. The neutral beam processing apparatus employs the configuration using a retarding electrode as charged particle separating means. In the case of converting an ion beam pulled out from an ion source to a neutral beam and irradiating an object to be processed with only the neutral beam, the charged particle separating means separates the neutral beam obtained by a charge exchanging reaction between a part of the ion beam and a neutral gas from the charged particle. The retarding electrode is a multi-aperture electrode having a number of small apertures for passing the neutral beam. By applying a predetermined potential to the multi-aperture electrode, while ions or electrons as the charged particles are electrostatically removed by repulsion, a neutral beam having no charge is allowed to pass.

The publication also discloses another charged particle separating means for magnetically separating electrons in charged particles from a neutral beam by applying a transverse magnetic field to the surface by a permanent magnet disposed on a side of an object to be processed and electrostatically separating ions in the charged particles from the neutral beam by applying a positive potential to a supporting stand for supporting the process object.

In the neutral beam processing apparatus, in order to process a larger object and shorten processing time, it is demanded to enlarge the diameter of a neutral beam to be applied on the object to be processed and to increase the capacity of the neutral beam. Moreover, it is requested to enlarge the diameter and increase the capacity while improving the quality of the neutral beam. That is, small divergence of the neutral beam and small variations in energy are requested.

According to the conventional techniques, for the following reasons, it is limited to enlarge the diameter and increase the capacity of a neutral beam while suppressing divergence of the neutral beam, removing surely the charged particles and reducing variations in energy.

Specifically, in the former one of the above conventional techniques, to achieve good quality of the neutral beam applied to the object to be processed, a retarding electrode has to be constructed by at least three multi-aperture electrodes as will be described hereinbelow. That is, the retarding electrode has to be constructed by a reference electrode to suppress divergence of a neutral beam and to reduce variations in energy, an ion eliminating electrode to eliminate ions, to which a positive potential with respect to the reference electrode is applied, and an electron eliminating electrode to eliminate electrons, to which a negative potential with respect to the reference electrode is applied.

The reference electrode is disposed on the ion source side among the three multi-aperture electrodes, and a predetermined potential is applied to the reference electrode, thereby specifying a space potential between the reference electrode and the pulling-out electrode. In the case where a gradient occurs in the space potential, for example, when the space potential is specified by the ion eliminating electrode set at a positive potential higher than the potential of the reference electrode and the pulling-out electrode in a state where there is no reference electrode, a gradient (potential barrier) occurs in the space potential between the pulling-out electrode and the ion eliminating electrode. An ion beam before conversion to a neutral beam largely diverges and the energy varies largely. In order to flatten the space potential in the neutralization area in which the ion beam is converted to the neutral beam, the following configuration is employed. The reference electrode is provided to the ion source side more than the ion eliminating electrode, and the reference electrode is set at a predetermined potential lower than the potential of the ion eliminating electrode, thereby flattening the space potential in the neutralization area. By providing the reference electrode to flatten the space potential, the divergence of the neutral beam can be suppressed, and the variations in energy can be reduced.

The larger the number of electrodes constructing the retarding electrode is, the higher the probability that the neutral beam collides with the electrodes becomes. It therefore causes a problem such that the amount of the neutral beam passing through the retarding electrode and applied to an object to be processed decreases.

It becomes more difficult to maintain a number of apertures formed in a plurality of electrodes at predetermined positions as the diameter of the retarding electrode becomes large. The neutral beam transmittance deteriorates and an decrease in output is caused. Due to the action of flattening the space potential in the neutralization area, the reference electrode inevitably is collided by the ion beam which is not neutralized, so that the reference electrode wears very much.

According to the latter one of the conventional techniques, by applying a parallel magnetic field generated by a permanent magnet disposed on a side of an object to be processed onto the surface of the object, electrons are magnetically separated from the neutral beam. By applying a positive potential to the object, ions are electrostatically separated from the neutral beam. Consequently, unlike the former conventional technique, the amount of the neutral beam applied on the object does not decreases due to the collision of the neutral beam with the retarding electrode.

By the positive potential applied to the object, however, a gradient occurs in the space potential in the neutralization area. Consequently, the ion beam before conversion to the neutral beam diverges largely and the energy varies largely. As a result, the neutral beam obtained by converting the ion beam diverges largely and the energy varies largely.

As the size of an object to be processed increases, the permanent magnet disposed on a side of the object becomes very large to generate a magnetic field necessary to separate electrons in the center portion of the object. Moreover, the difference between the magnetic field intensity in the center portion of the object and that in an end portion is conspicuous and an influence on the charged particles becomes non-uniform. Consequently, the enlargement of the diameter in the neutral beam processing apparatus is limited. There are problems such that the apparatus is not suitable for a process on an object which is easily influenced by a magnetic field such as a magnetic device since the magnetic field is generated on the surface of the object, and is not suitable for a process on an object of which surface is made of an insulator since ions are removed by applying a predetermined positive potential to the object.

As described above, in the conventional techniques, there is a limit of increase in the diameter and capacity of the neutral beam while suppressing the divergence of the neutral beam applied on the object to be processed, removing surely the charged particles and reducing the variations in energy.

### SUMMARY OF THE INVENTION

An object of the invention is to provide a neutral beam processing apparatus an method using a neutral beam having an enlarged diameter and an increased capacity while suppressing divergence of the neutral beam, removing surely the charged particles and reducing variations in energy.

In order to achieve the object, according to the invention, as a first means, there is provided a neutral beam processing apparatus having: an ion source; an ion pulling-out electrode for pulling out ions from the ion source and generating an ion beam; a neutralization cell for neutralizing and converting the ion beam pulled out by the ion pulling-out electrode in atmosphere of a neutral gas to a neutral beam; charged particle separating means for separating charged particles from the neutral beam in the neutralization cell and allowing a neutral beam to pass; and a process cell disposed adjacent to the neutralization cell, for housing an object to be processed on a propagation path of the neutral beam passed through the charged particle separating means, wherein the charged particle separating means includes a multi-aperture electrode having a plurality of apertures through which the neutral beam passes, and a plurality of lines of magnets dispersively disposed adjacent to the multi-aperture electrode, for generating a multi-pole magnetic field near the multi-aperture electrode.

According to the invention, as a second means, there is also provided a neutral beam processing apparatus having: an ion source; an ion pulling-out electrode for pulling out ions from the ion source and generating an ion beam; a neutralization cell for neutralizing and converting the ion beam pulled out by the ion pulling-out electrode in atmosphere of a neutral gas to a neutral beam; charged particle separating means for separating charged particles from the neutral beam in the neutralization cell and allowing a neutral beam to pass; and a process cell disposed adjacent to the neutralization cell, for housing an object to be processed on a propagation path of the neutral beam passed through the charged particle separating means, wherein the charged particle separating means includes a multi-aperture electrode to which a positive potential with respect to a neutralization cell wall defining the neutralization cell is applied and which has a plurality of apertures through which the neutral beam passes, a plurality of lines of magnets dispersively disposed adjacent to the multi-aperture electrode, for generating a multi-pole magnetic field near the multi-aperture electrode, and a conductive member which is disposed in a magnetic pole portion of the multi-pole magnetic field in the neutralization cell and to which a negative potential with respect to the multi-aperture electrode is applied.

Any of the following elements can be added to the configuration of the neutral beam processing apparatus.

(1) The plurality of magnet lines also serve as the conductive member.

(2) The plurality of magnet lines are disposed so as to face the conductive member over the multi-aperture electrode.

(3) Potential difference adjusting means for making a potential difference between a neutralization cell wall defining the neutralization cell and the conductive member may also be provided.

(4) Electron replenishing means for supplying or generating electrons in the neutralization cell may also be provided.

(5) According to the invention, as a second means, there is also provided, as a third means, a neutral beam processing apparatus comprising: an ion source, an ion pulling-out electrode for pulling out ions from the ion source and generating an ion beam, a neutralization cell for neutralizing and converting the ion beam pulled out by the ion pulling-out electrode in atmosphere of a neutral gas to a neutral beam, charged particle separating means for separating charged particles from the neutral beam in the neutralization cell and allowing a neutral beam to pass, and a process cell disposed adjacent to the neutralization cell, for housing an object to be processed on a propagation path of the neutral beam passed through the charged particle separating means, wherein, to a process cell wall for defining the process cell, a mean for giving a negative potential to a plasma generation cell wall for defining the ion source is provided, and to the plasma generation cell wall, a mean for giving a negative potential to a neutralization cell wall for defining the neutralization cell is provided.

The invention also provides a neutral beam processing method comprising the steps of: pulling out ions from an ion source to generate an ion beam; converting the ion beam into a neutral beam in a neutralization cell; separating and removing ions from charged particles existing in the neutral beam by disposing a multi-aperture electrode on an outlet side of the neutralization cell; generating a multi-pole magnetic field around the multi-aperture electrode by disposing a plurality of magnets near the multi-aperture electrode; separating and removing electrons from charged particles existing in the neutral beam by the multi-pole magnetic field; and irradiating an object to be processed in a process cell with the neutral beam passed through the multi-aperture electrode.

Further, the invention provides a neutral beam processing method comprising the steps of: pulling out ions from an ion source and introducing the ions as an ion beam into a neutralization cell; generating a multi-pole magnetic field around a multi-aperture electrode to which a positive potential with respect to a neutralization cell wall defining the neutralization cell is applied by disposing the multi-aperture electrode on an outlet side of the neutralization cell and disposing a plurality of magnets near the multi-aperture electrode; converting the ion beam into a neutral beam in a space potential area which is flat in a wide range in the neutralization cell and is formed by disposing a conductive member to which a negative potential with respect to the multi-aperture electrode is applied in a magnetic pole portion of the multi-pole magnetic field in the neutralization cell, separating and removing ions in charged particles included in the neutral beam by the multi-aperture electrode; separating and removing electrons in the charged particles by the multi-pole magnetic field; and irradiating an object to be processed in a process cell with the neutral beam passed through the multi-aperture electrode.

Further, according to the present invention, a neutral beam processing method comprising the steps of pulling out ions from an ion source and introducing the ions as an ion beam into a neutralization cell, converting the ion beam into a neutral beam in a neutralization cell, removing charged particles from the neutral beam by a charged particle removing means; and irradiating an object to be processed in a process cell with the neutral beam passed through the charged particle removing means, wherein, to a process cell wall for defining the process cell, giving a negative potential to a plasma generation cell wall for defining the ion source, and further giving a negative potential to a neutralization cell wall for defining the neutral cell, thereby the ion beam pulled-out from the ion source is prevented from reaching to the process cell.

According to the above stated first means, since the ions in charged particles included in a neutral beam are separated and removed from the neutral beam by a multi-aperture electrode, and the electrons are separated and removed from the neutral beam by a multi-pole magnetic field generated by a plurality of magnet lines. Consequently, the charged particles can be removed surely from the neutral beam.

Further, according to the second means, the transmittance can be increased as compared with the technique of using a plurality of electrodes as the charged particle separating means, and the capacity of the neutral beam can be prevented from being decreased. Thus, the capacity of the neutral beam can be increased. Further, by increasing the number of magnet lines with the upsizing of the multi-aperture electrode, the diameter of the neutral beam can be enlarged. Further, since the positive potential to repel the ions is applied to the multi-aperture electrode, a wear due to collision with an ion beam can be avoided. By providing a conductive member as the charged particle separating means, the magnet line can be prevented from being irradiated with the ion beam, so that demagnetization caused by heating the magnet line can be prevented.

Further, according to the third means, to the process cell wall for defining the process cell, the negative potential is given to the plasma generation cell wall for defining the ion source, the ion beam pulled out from the ion source can be prevented from centering to the process cell.

### BRIEF DESCRIPTION OF THE DRAWINGS

FIG. 1A is a vertical section of a neutral beam processing apparatus as a first embodiment of the invention, and

FIG. 1B is a characteristic diagram of a space potential of the apparatus shown in FIG. 1A;

FIG. 2A is an enlarged cross section of a main portion of charged particle separating means, and

FIG. 2B is a characteristic diagram of a space potential around the charged particle separating means shown in FIG. 2A;

FIG. 3A is a vertical section of a neutral beam processing apparatus as a second embodiment of the invention, and

FIG. 3B is a characteristic diagram of a space potential of the apparatus shown in FIG. 3A;

FIG. 4 is an enlarged cross section of a main portion of the apparatus shown in FIG. 3A; and

FIG. 5A is a vertical section of a neutral beam processing apparatus as a third embodiment of the invention, and

FIG. 5B is a characteristic diagram of a space potential of the apparatus shown in FIG. 5A.

### DETAILED DESCRIPTION OF THE PREFERRED EMBODIMENTS

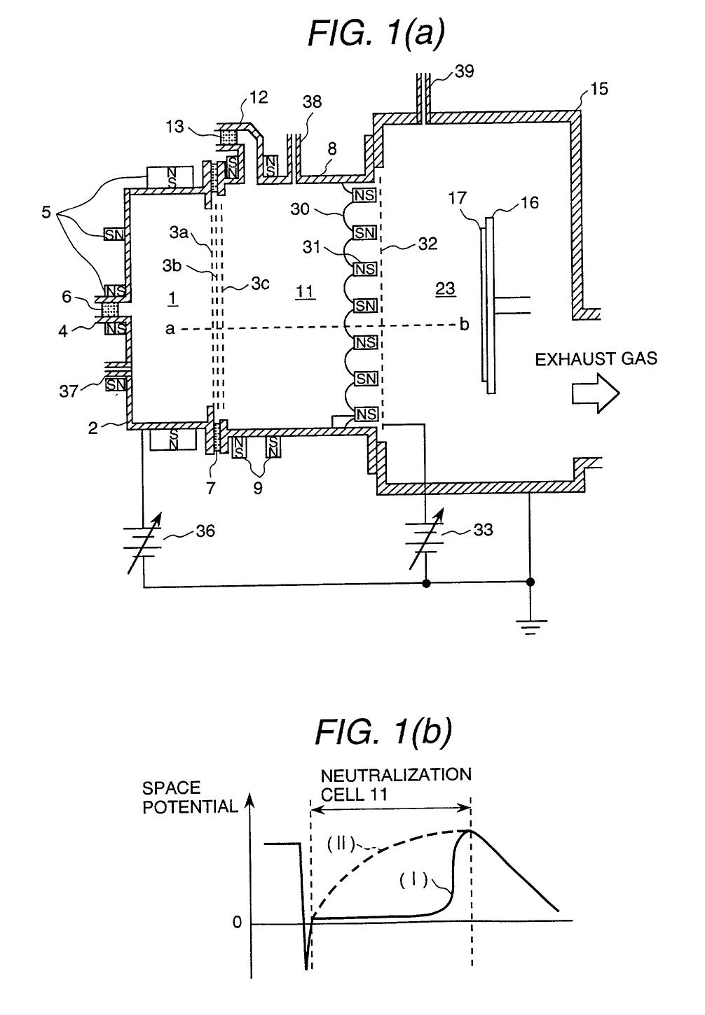

A neutral beam processing apparatus and a method of a neutral beam processing of a first embodiment according to the present invention will now be described hereinbelow with reference to the drawings. FIG. 1A is a vertical section showing a general configuration of a neutral beam processing apparatus as the first embodiment of the invention, and FIG. 1B is a characteristic diagram of a space potential of the apparatus shown in FIG. 1A.

In FIG. 1A, the neutral beam processing apparatus has an ion source for generating a plasma by microwave discharge. In the ion source, a plasma production cell 1 is defined by a production cell wall 2, and a waveguide 4 and a gas introducing tube 37 are connected to the production cell wall 2. The plasma production cell 1 has an inner diameter in the vertical direction in FIG. 1A of φ350 mm and a depth in the lateral direction of 150 mm. For example, the plasma producing cell 1 is formed almost in a bowl shape by the production cell wall 2 made of a non-magnetic material such as stainless steel. The right side of the plasma production cell 1 is open. The waveguide 4 is connected to the center portion on the left side of the production cell wall 2. A microwave introducing window 6 is attached to the inside of the waveguide 4 so as to maintain the air tightness in the plasma production cell 1. A microwave generator (not shown) is connected to the waveguide 4. A microwave having a frequency of 2.45 GHz generated from the microwave generator is introduced through the waveguide 4 and the microwave introducing window 6 into the plasma production cell 1. The gas introducing tube 37 is connected to the production cell wall 2 in a position lower than the waveguide 4. A specific gas necessary for plasma production, for example, argon gas is introduced into the plasma production cell 1 via the gas introducing tube 37.

On the outer periphery side of the production cell wall 2, permanent magnets 5 are lined (permanent magnet line). The permanent magnet line 5 can generate a magnetostatic field having an electron cyclotron resonance field in the plasma production cell 1. The bottom side of the production cell wall 2 is connected to a direct voltage source 36 and a direct voltage of, for example, 600V to 1000V is applied to the production cell wall 2.

Further, a flange is formed on the open side of the production cell wall 2, and an ion pulling-out electrode for pulling out the ions in the plasma production cell 1 to generate an ion beam is attached to the open side of the production cell wall 2. The ion pulling-out electrode is constructed by a screen electrode 3a, an accelerating electrode 3b, and a decelerating electrode 3c. The screen electrode 3a is disposed on the plasma production cell 1 side, the accelerating electrode 3b is disposed on the right side of the screen electrode 3a, and the decelerating electrode 3a is disposed on the right side of the accelerating electrode 3b. In each of the screen electrode 3a, accelerating electrode 3b, and decelerating electrode 3c, a plurality of apertures each having a predetermined size are formed at predetermined intervals. In the embodiment, the area in which the plurality of apertures in the ion pulling-out electrode are distributed has a size of φ300 mm. Since the positive polarity of the direct voltage source 36 is connected to the production cell wall 2 and the negative polarity of the direct voltage source 36 is connected to a process cell wall 15, a positive potential with respect to the process cell wall 15 is applied to the production cell wall 2.

A neutralization cell 11 is connected to the open side of the plasma production cell 1 having the above configuration. The neutralization cell 11 is formed in an almost cylindrical shape and defined by a neutralization cell wall 8. A waveguide 12 and a gas introducing tube 38 are connected to the neutralization cell wall 8.

The neutralization cell wall 8 is formed in a cylindrical shape having, for example, an inner diameter of 400 mm and a depth of 350 mm and is made of a non-magnetic stainless steel. A flange formed at the left end in the axial direction is connected to the flange formed at the right end of the production cell wall 2 via an insulative spacer 7. A flange formed at the right end in the axial direction is connected to the process cell wall 15. Both the flange and the process cell wall 15 are connected to the ground. The neutralization cell wall 8 is used to enclose an ion beam pulled out from the plasma production cell 1. On the outer periphery of the neutralization cell wall 8, two sets of permanent magnetic lines 9 are arranged in the axial direction (lateral direction) so that the polarities of the magnets in each set are different from each other. Each of the permanent magnet lines 9 is provided to generate a multi-ring cusp field having the electron cyclotron resonance magnetic field in the neutralization cell 11. The permanent magnet line 9 is made of, for example, samarium cobalt (having residual magnetic flux density of about 1.1 T) and has a thickness of 8 mm and a length in the magnetization direction of 12 mm.

On the outer periphery of the neutralization cell wall 8, the waveguide 12 is attached in the direction orthogonal to the axial direction of the neutralization cell wall 8. The waveguide 12 is disposed between the two sets of the permanent magnet lines 9 on the outer periphery of the neutralization cell wall 8 and introduces a microwave having a frequency of 2.45 GHz from neighboring magnetic poles of the multi-ring cusp fields in the neutralization cell wall 8. The permanent magnet lines 9 generate multi-ring cusp fields and also generate an electron cyclotron resonance magnetic field corresponding to the frequency of the microwave. Further, in order to introduce a microwave and maintain the air tightness in the neutralization cell 11, in a manner similar to the waveguide 4, the waveguide 12 is provided with a microwave introducing window 13 made of quartz, alumina, or the like.

A multi-aperture electrode 32 as an element of the neutralization cell 11 and a process cell 23, which defines the neutralization cell 11 and the process cell 23 is attached to the right-side opening of the neutralization cell wall 8. In the multi-aperture electrode 32, a plurality of apertures each having a predetermined size are formed as passages of the neutral beams at predetermined intervals. The positive polarity of the direct voltage source 33 is connected to the multi-aperture electrode 32, and a direct voltage of, for example, 700 V is applied to the multi-aperture electrode 32. Consequently, a positive potential with respect to the neutralization cell wall 8 having the same potential as that of the process cell wall 15 is applied to the multi-aperture electrode 32. In the embodiment, the area in which the plurality of apertures are distributed in the multi-aperture electrode 32 has a size of φ350 mm.

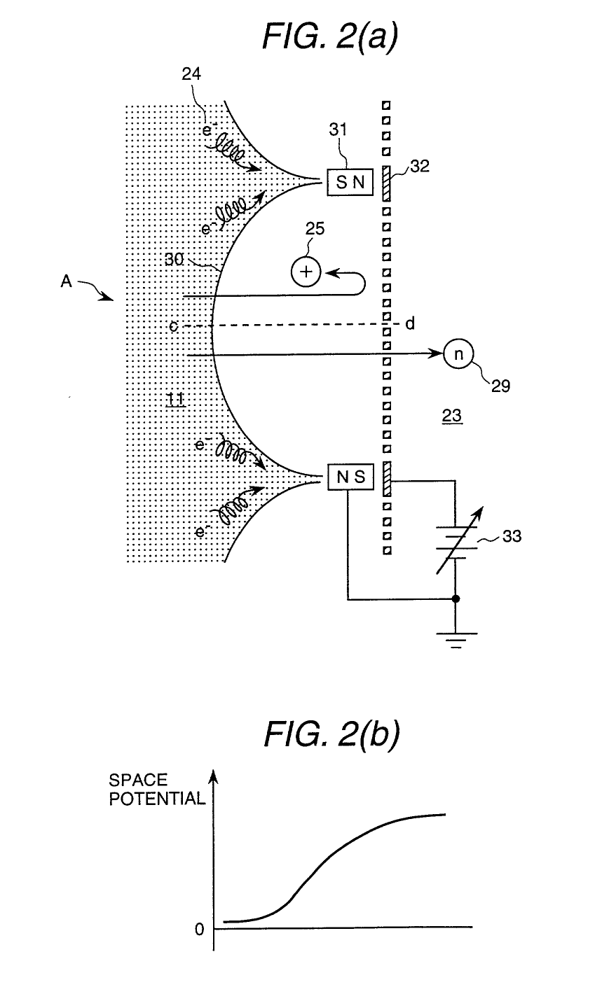

A plurality of permanent magnet lines 31 as magnetic bodies are disposed adjacent to the multi-aperture electrode 32. Each of the permanent magnetic lines 31 is disposed so that the poles are perpendicular to the surface of the multi-aperture electrode 32 and the polarities of neighboring permanent magnet lines are different from each other. The permanent magnet lines 31 are fixed to the multi-aperture electrode 32 by using, for example, an insulating member. By the plurality of permanent magnetic lines 31, multi-pole magnetic fields 30 are generated around the multi-aperture electrode 32 in the neutralization cell 11. The permanent magnet line 31 is made of samarium cobalt (having residual magnetic flux density of about 1.1 T) which is a conductive material, and has a thickness of 4 mm and a length in the magnetizing direction of 8 mm. The neighboring permanent magnet lines are set with an interval of 50 to 60 mm. The magnetic field strength of the multi-pole magnetic field 30 generated by the permanent magnet lines 31 becomes the maximum at about 10 mT in a line segment cd shown in FIG. 2A, drastically decreases with distance from the maximum value position (almost at midpoint between a line segment indicative of a line of magnetic force of the multi-pole magnetic field 30 and the multi-aperture electrode 32). The magnetic field strength is about 3 mT at a position away from the multi-aperture electrode 32 by 50 mm, and is about 1 mT at a position away from the multi-aperture electrode 32 by 80 mm. The line of magnetic force representatively shown as the multi-pole magnetic field 30 has the magnetic field strength of about 1 to 3 mT on the line segment cd. The permanent magnet line 31 is connected to the neutralization cell wall 8 via a conductive member (wire) and connected to the ground so that its potential is the same as that of the neutralization cell wall 8.

The process cell 23 is connected on the right side of the neutralization cell 11. The process cell 23 is a space for housing an object 17 to be processed such as a substrate and for processing the process object 17 with a neutral beam passed through the multi-aperture electrode 32. The process cell 23 is defined by the process cell wall 15 made of a non-magnetic material such as a stainless steel. A gas introducing tube 39 for introducing a specific gas such as argon or halogen gas into the process cell 23 is connected to the process cell wall 15. The process object 17 is disposed in a position on a propagation path of the neutral beam passed through the multi-aperture electrode 32 so as to be almost orthogonal to the neutral beam and is supported by a supporting stage 16. The supporting stage 16 is connected to the ground in a manner similar to the process cell wall 15.

The neutral beam processing apparatus in the embodiment is constructed as described above. Its action will now be described. First, the process cell 23 is exhausted by using a vacuum pump (not shown) as shown by the arrow, thereby setting the pressure in the process cell 23 to 1×10⁻⁴ Pa or lower. Subsequently, a gas such as argon gas is supplied from the gas introducing tube 37, 38, or 39 into the plasma production cell 1 to thereby set the pressure in the plasma production cell 1 to 3×10⁻² Pa to 3×10⁻¹ Pa. After that, a microwave of 2.45 GHz is introduced via the waveguide 4.

Consequently, in the plasma producing cell 1, a plasma is generated from the supplied gas with the microwave. In an area of a magnetic field intensity of, for example, about 87.5 mT at which the cyclotron resonance frequency of the electrons in the plasma and the microwave frequency coincide with each other, the microwave is efficiently absorbed by the electrons in the plasma. A high energy electron generated ionizes the gas, thereby generating a high-density plasma.

At this time, when the production cell wall 2 and the screen 3a in the ion source are set at a positive potential with respect to the neutralization cell wall 8 by the direct voltage source 36, and the accelerating electrode 3b is set at a negative potential with respect to the neutralization cell wall 8, only the ions are pulled out as an ion beam from the high-density plasma in the plasma production cell 1 into the neutralization cell 11. The decelerating electrode 3c is set at the ground potential in a manner similar to the neutralization cell wall 8.

When the ion beam is pulled out into the neutralization cell 11, a part of the ion beam is converted to a neutral beam by a neutralizing action which will be described hereinlater in the neutralization cell 11. The electrons and ions mixedly existing in the neutral beam are separated from the neutral beam by a charged particle separating action which will be described hereinlater. Only the neutral beam passes through the multi-aperture electrode 32, is led into the process cell 23, and falls onto the process object 17 on the supporting stage 16. In such a manner, a desired neutral beam process such as a neutral beam etching process can be performed on the process object 17. At this time, according to a desired neutral beam process, by introducing a specific gas such as, for example, halogen gas from the gas introducing tube 39 in the case of a neutral beam etching process, the effect on the process can be increased.

The action of neutralizing the ion beam in the neutralization cell 11 will now be described. The pressure in the neutralization cell 11 is set to 3×10⁻² Pa to 3×10⁻¹ Pa by supplying the specific gas such as argon gas from the gas introducing tube 38 into the neutralization cell 11. After that, when the ion beam is introduced into the neutralization cell 11, a part of the ion beam is converted to a neutral beam by a charge exchange reaction with the neutral gas (neutral particles of the specific gas).

In the case of converting the ion beam into the neutral beam, when it is assumed that the permanent magnetic lines 31 are not connected to the ground together with the neutralization cell wall 8 but are set at the same potential as that of the multi-aperture electrode 32, that is, at a positive potential with respect to the neutralization cell wall 8, as a spatial potential on a line segment ab in FIG. 1A, a spatial potential in the neutralization cell 11 between the decelerating electrode 3c and the multi-aperture electrode 32 is specified by the potentials of the decelerating electrode 3c and the multi-aperture electrode 32. As shown by the broken line (II) in FIG. 1B, the space potential which increases toward the multi-aperture electrode 32 is generated in the neutralization cell 11. In this case, a secondary electron is generated by collision between the ion beam and the neutralization cell wall 8. Even when the secondary electron is supplied to the neutralization cell 11, the electron is easily absorbed by the magnetic poles of the permanent magnet line 31 which is set at the positive potential, and cannot stay long in the neutralization cell 11. Consequently, many ion beams having relatively positive charges and many low-energy ions generated by the charge exchange between the ion beam and the neutral gas exist in the neutralization cell 11. As a result, the ion beam passing through the area of the space potential having the gradient diverges due to an influence of the potential barrier and is further decelerated, and the kinetic energy decreases. Also in the case where the ion beam is converted to the neutral beam by the charge exchange reaction with the neutral gas in the neutralization cell 11, the neutral beam after the conversion diverges largely, and the energy varies largely.

On the other hand, in the embodiment, the permanent magnetic line 31 is set at the same potential as that of the neutralization cell wall 8, that is, the permanent magnetic line 31 is connected to the ground together with the neutralization cell wall 8. Consequently, the space potential between the decelerating electrode 3c and the permanent magnet line 31 can be specified by the potentials of the decelerating electrode 3c and the neutralization cell wall 8. Therefore, when the ion beam collides with the neutralization cell wall 8, thereby generating the secondary electron, and the secondary electron is supplied to the neutralization cell 11, the secondary electron is not easily absorbed by the magnetic pole of the permanent magnet line 31 but, rather, reflected by a mirror effect of the magnetic pole of the permanent magnet line 31. Consequently, in FIG. 2A, in the space area A where electrons can easily move and which is wide in the radial and axial directions in the neutralization cell 11, a plasma can be formed by the electrons with the low-energy ions generated in the process of neutralizing the ion beam. By the formation of the plasma, in the space area A which is wide in the radial and axial directions in the neutralization cell 11, as shown by the solid line (I) in FIG. 1B, the space potential is flattened as a potential close to the neutralization cell wall 8. As a result, the ion beam passing through the wide space area A does not diverge. Moreover, the ion beam is not decelerated and the kinetic energy is not decreased. Thus, the neutral beam generated in the wide space area A does not diverge so much in the large-diameter area and variations in energy are suppressed.

The case of using the secondary electrons generated by the collision of the ion beam with the neutralization cell wall 8 in the process of forming the plasma in the space area A and flattening the space potential in the neutralization cell 11 has been described above. This is effective only when the amount of the ion beam is relatively small. Specifically, in the case of introducing an ion beam of a heavier current into the neutralization cell 11 and neutralizing the ion beam to thereby obtain a larger amount of a neutral beam, only with electrons generated secondarily such as secondary electrons, there is a limitation of neutralizing the positive charge of the ion beam to thereby flatten the space potential.

In the embodiment, therefore, as described above, as electron replenishing means for supplying or generating an electron or plasma in the neutralization cell 11, the waveguide 12, gas introducing tube 38, and permanent magnet line 9 are provided to generate the multi-ring cusp magnetic field having the electron cyclotron resonance field in the neutralization cell 11, introduce the microwave from the waveguide 12 into the neutralization cell 11, and generate the plasma in the neutralization cell 11 by the interaction between the microwave and the electron cyclotron resonance field. Since the density of the plasma can be adjusted by the strength of the microwave to be introduced, even when the ion beam introduced into the neutralization cell 11 is of a heavy current, by generating a plasma of a predetermined density according to the heavy current, the space potential can be flattened with reliability as a potential close to the neutralization cell wall 8 as shown by the solid line (I) in FIG. 1B in the space area A which is wide in the radial and axial directions in the neutralization cell 11. Therefore, the ion beam passing through the space area A does not diverge and is not decelerated, and the kinetic energy does not decrease. Thus, the neutral beam of a large capacity generated by neutralizing the ion beam of the heavy current in the space area A, which does not diverge so much in the large-diameter area with small variations in the energy can be obtained.

Referring now to FIGS. 2A and 2B, the action of the charged particle separating means according to the invention will be described. In the embodiment, the charged particle separating means is constructed by the multi-aperture electrode 32 to which a positive potential with respect to the neutralization cell wall 8 is applied and the plurality of magnet lines 31 for generating the multi-pole magnetic field 30 around the multi-aperture electrode 32.

In the case of separating the ion beam and the low-energy ion by using the charged particle separating means, in the embodiment, the multi-aperture electrode 32 is set at a positive potential with respect to the neutralization cell wall 8 by a power source 33. The positive potential is higher than the positive potential set for the production cell wall 2 and the screen electrode 3a in the ion source. On the other hand, the permanent magnet line 31 is set at the same potential (ground potential) as that of the neutralization cell wall 8. By the setting of the potentials, around the multi-aperture electrode 32 shown by the line segment cd in FIG. 2A, the space potential which increases toward the multi-aperture electrode 32 is generated as shown by the solid line in FIG. 2B.

By the generation of the space potential which sharply increases as the space potential between the permanent magnet line 31 and the multi-aperture electrode 32, ions 25 including the ion beam and the low-energy ion are returned by the potential barrier of the space potential back to the inside of the neutralization cell wall 11 before reaching the multi-aperture electrode 32. The ions 25 cannot pass through the multi-aperture electrode 32 and enter the process cell 23.

An electron 24 having a small Larmor radius due to a magnetic field cannot cross the multi-pole magnetic field 30 generated around the multi-aperture electrode 32 by the permanent magnet line 31 and cannot reach the multi-aperture electrode 32. The electron 24 goes along the line of magnetic force of the multi-pole magnetic field 30, collides with the magnetic pole of the permanent magnet line 31, and vanishes, or is reflected by the mirror effect. Consequently, the electron 24 cannot pass through the multi-aperture electrode 32 and enter the process cell 23.

In contrast with the charged particles, the course of the neutral beam 29 is not deviated by both the magnetic field and the space potential, and the neutral beam 29 can easily reach the multi-aperture electrode 32. The neutral beam 29 passes through the apertures in the multi-aperture electrode 32 at random, enters the process cell 23, and is applied on the process object 17.

As described above, the charged particle separating means in the embodiment uses only one multi-aperture electrode 32. Consequently, as compared with the conventional technique using the retarding electrode made by a plurality of multi-aperture electrodes, in the case of enlarging the diameter of the neutral beam, there is no difficulty to keep a number of apertures opened in the plurality of electrodes in predetermined positions, so that the diameter of the neutral beam can be easily enlarged. Since the number of electrodes is small and the probability that the neutral beam collides the electrode is low, the reduction amount of the neutral beam passing through the electrode and applied on the process object 17 can be decreased. That is, the neutral beam transmission can be improved. Since the positive potential to repel ions is applied to the multi-aperture electrode 32, the multi-aperture electrode 32 can be prevented from being worn due to the collision with the ion beam.

Further, as compared with the conventional technique to magnetically separate and remove the electrons by applying a parallel magnetic field onto the surface of the object to be processed by the permanent magnet arranged on the side face of the process object 17, the permanent magnet line 31 for forming the multi-pole magnetic field 30 is used in the neutralization cell 11 in the embodiment. Consequently, the beam diameter can be easily enlarged by increasing the number of lines of the permanent magnet lines 31 without enlarging the permanent magnet. Since the magnetic field strength of the multi-pole magnetic field 30 generated by the permanent magnet line 31 sharply attenuates with distance from the permanent magnet line 31, by disposing the process object 17 in a position apart from the permanent magnet line 31 in the process cell 23, an influence of the magnetic field onto the process object 17 can be eliminated. Even in the case of an object to be processed such as a magnetic device which is easily influenced by the magnetic field, the neutral beam process can be performed with reliability. Since ions are removed by repulsion by the multi-aperture electrode 32, as compared with the conventional technique of removing ions by repulsion by applying the positive potential to the process object 17, even when the process object is an insulator, the neutral beam process can be carried out with reliability.

According to the embodiment, a neutral beam which does not diverge so much in the neutralization cell 11 with small variations in energy and has, moreover, a large diameter and a large capacity can be generated. Further, the neutral beam from which charged particles are separated and removed in the area of the large diameter by the charged particle separating means with reliability can be applied onto the process object 17. Consequently, the process object 17 can be subjected to the neutral beam process using a neutral beam having a large diameter and a large capacity with small variations in energy.

In the embodiment, in place of connecting the permanent magnet line 31 directly to the neutralization cell wall 8, the permanent magnet line 31 and the neutralization cell wall 8 are connected to each other via a direct current source. The permanent magnet line 31 can be set at a negative potential with respect to the neutralization cell wall 8, which is according to an output voltage of the direct voltage source.

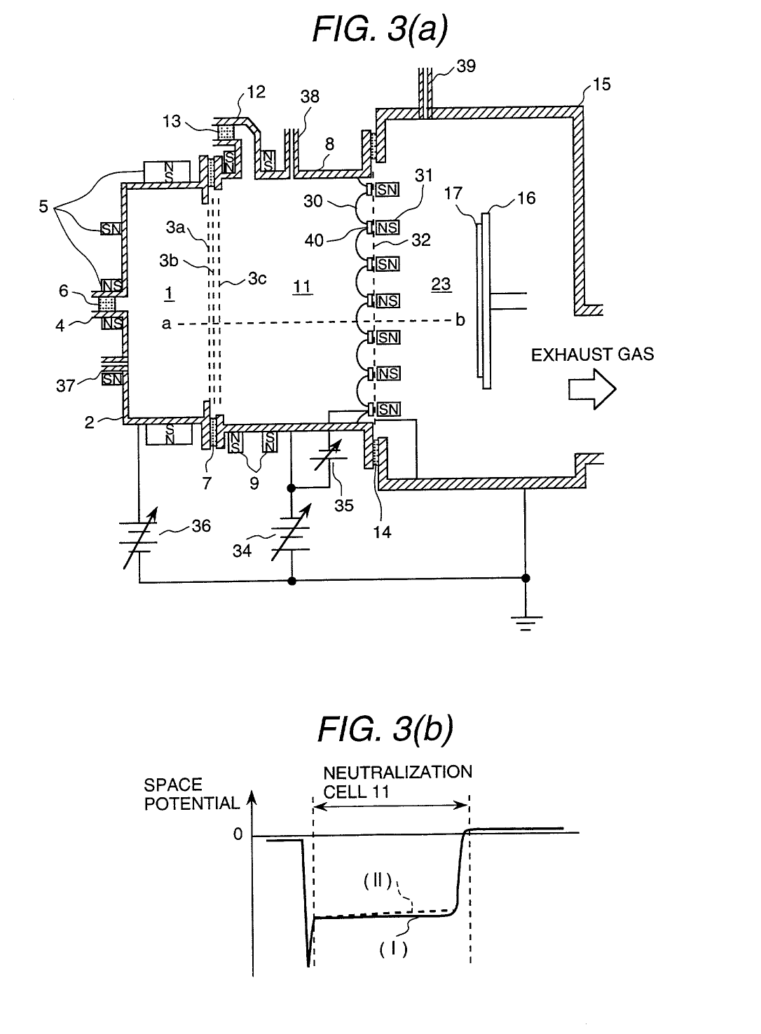

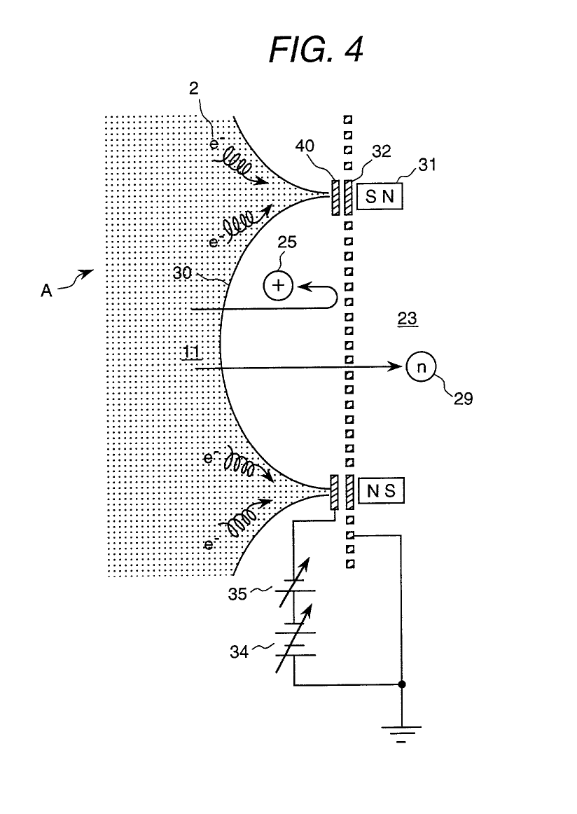

A second embodiment of the invention will now be described with reference to FIGS. 3A and 3B and FIG. 4. FIG. 3A is a vertical section of a neutral beam processing apparatus as another embodiment of the invention. FIG. 3B is a characteristic diagram of the spatial potential of the apparatus shown in FIG. 3A. FIG. 4 is an enlarged section of a main portion of the apparatus illustrated in FIG. 3A.

In the another embodiment, three problems of the foregoing embodiment are solved in the following manner. The charged particle separating means is constructed by the multi-aperture electrode 32, permanent magnet line 31, and a plurality of conductive members 40. The permanent magnet line 31 is disposed in the process cell 23. The plurality of conductive members 40 are disposed in the neutralization cell 11 so as to face the permanent magnet line 31 via the multi-aperture electrode 32. Each of the conductive members 40 is connected to a direct voltage source 35. An insulative spacer 14 is inserted between the neutralization cell wall 8 and the process cell wall 15. The process cell wall 15 is connected to the ground together with the supporting stage 16. A voltage of, for example, −50V is applied from the direct voltage source 36 to the production cell wall 2. A voltage of, for example, −650V is applied from the direct voltage source 34 to the neutralization cell wall 8. A direct voltage of 0 to +30V is applied from the direct voltage source 35 to each of conductive members 40.

Specifically, the foregoing embodiment has the three problems as described below.

(1) Since the permanent magnet line 31 is disposed in the neutralization cell 11, the permanent magnet line 31 is heated by collision with the ion beam and the neutral beam. Depending on the degree of heating, the permanent magnet line 31 may be demagnetized.

(2) Since the neutralization cell wall 8 is at the same potential as the process cell wall 15, the multi-aperture electrode 32 to which the positive potential with respect to the neutralization cell wall 8 is applied to remove the ion beam by repulsion has the positive potential also with respect to the process cell wall 15. Consequently, secondary electrons generated when the process object 15 is irradiated with the neutral beam are electrostatically attracted by the multi-aperture electrode 32. When the surface of the process object 17 is made of an insulating material, positive charges are residual on the surface of the insulating material. The surface of the process object 17 can be therefore charged at a positive potential largely with respect to the process cell wall 15.

(3) In the case where the apparatus is used for an application requiring high-accuracy control on a generation amount of a neutral beam, for example, a case of optimizing a process shape of a process object in a neutral beam etching process, a parameter which can control the neutral beam divergence amount is only the intensity of a microwave guided from the waveguide 12 into the neutralization cell 11 in order to generate a plasma. Consequently, it is difficult to address the requirement depending on the accuracy of the control required.

In contrast, in the another embodiment, the permanent magnet line 31 is disposed in the process cell 23, the neutralization cell wall 8 is connected to the process cell wall 15 via the insulative spacer 14, the neutralization cell wall 8 is set at a negative potential with respect to the process cell wall 15 by the direct voltage source 34, and the multi-aperture electrode 32 is set at the same ground potential as that of the process cell wall 15. Further, the conductive members 40 are provided for the magnet pole portions of the multi-pole magnetic fields 30 generated in the neutralization cell 11 by the permanent magnet line 31, and the potential of the conductive member 40 is varied with respect to the neutralization cell wall 8 by the direct voltage source 35 as potential difference adjusting means.

Consequently, according to the embodiment, since the permanent magnet line 31 is disposed in the process cell 23, the permanent magnet line 31 is not irradiated with the ion beam. Moreover, the permanent magnet line 31 is positioned behind the multi-aperture electrode 32 and is not therefore also irradiated with the neutral beam. Consequently, the demagnetization due to the heating of the permanent magnet line 31 can be prevented.

According to the embodiment, since the multi-aperture electrode 32 is connected to the ground so as to be set at the same potential as that of the process cell wall 15, secondary electrons generated when the process object 17 is irradiated with the neutral beam are not electrostatically attracted by the multi-aperture electrode 32 but can return to the surface of the process object 17. Even when the surface of the process object 17 is made of an insulating material, the surface can be prevented from being charged at the positive potential largely with respect to the process cell wall 15. In this time, since the plasma generation cell wall 2 for defining the ion source is established to have the negative potential (−50 V) according to the direct current source 36, even when the multi-aperture electrode 32 has the ground potential, the ion beam pulled put from the ion source can be repelled and removed surely. Although it has been described in the embodiment that the potential of the multi-aperture electrode 32 is the same as that of the process cell wall 15, when they have almost the same potential, similar effects can be produced.

Further, in the embodiment, the conductive members 40 are disposed in the magnet pole portions of the multi-pole magnetic fields 30 generated in the neutralization cell 17 by the permanent magnet line 31, and the potential of the conductive member 40 is varied with respect to the neutralization cell wall 8 by the direct voltage source 35. Consequently, the gradient of the space potential in the neutralization cell 11 can be adjusted.

For example, when it is assumed that the voltage across the direct voltage source 35 is 0V, as a space potential on a line segment ab in FIG. 3A, as shown by the solid line (I) in FIG. 3B, the space potential can be flattened in the wide space area A in the neutralization cell 11 as a potential close to the neutralization cell wall 8.

When a voltage of, for example, +30V is generated across the direct voltage source 35 and a slightly positive potential with respect to the neutralization cell wall 8 is applied to the conductive member 40, as shown by the broken line (II) in FIG. 3B, a space potential which slightly increases toward the multi-aperture electrode 32 in the wide space area A in the neutralization cell 11 can be generated. An ion beam passing through such a space potential diverges slightly, so that the neutral beam generated by converting the ion beam diverges slightly. By controlling the output voltage of the direct voltage source 35, a neutral beam having a desired degree of divergence can be therefore easily obtained.

In the embodiment, as shown in FIG. 4, in the case of separating the electrons 24 from the neutral beam 29, the plurality of permanent magnet lines 31 are disposed around the multi-aperture electrode 32 to generate the multi-pole magnetic fields 30 around the multi-aperture electrode 32, the conductive members 40 to which a negative potential with respect to the multi-aperture electrode 32 is applied are disposed so as to face the permanent magnet line 31 over the multi-aperture electrode 32, and a potential slightly higher than that of the neutralization cell wall 8 is applied to the conductive member 40. Thus, the electrons 24 can be separated from the charged particles existing in the neutral beam 29 by the multi-pole magnetic fields 30 and the conductive members 40.

According to the embodiment, the neutral beam which does not diverge so much in the neutralization cell 11 with small variations in energy and has, moreover, a large diameter and a large capacity can be generated. Further, the process object 17 can be irradiated with the neutral beam from which the charged particles are separated and removed with reliability in the large-diameter area by the charged particle separating means. Consequently, the neutral beam process using a neutral beam with suppressed divergence and small variations in energy and, moreover, of a large diameter and a large capacity can be performed on the object 17 to be processed.

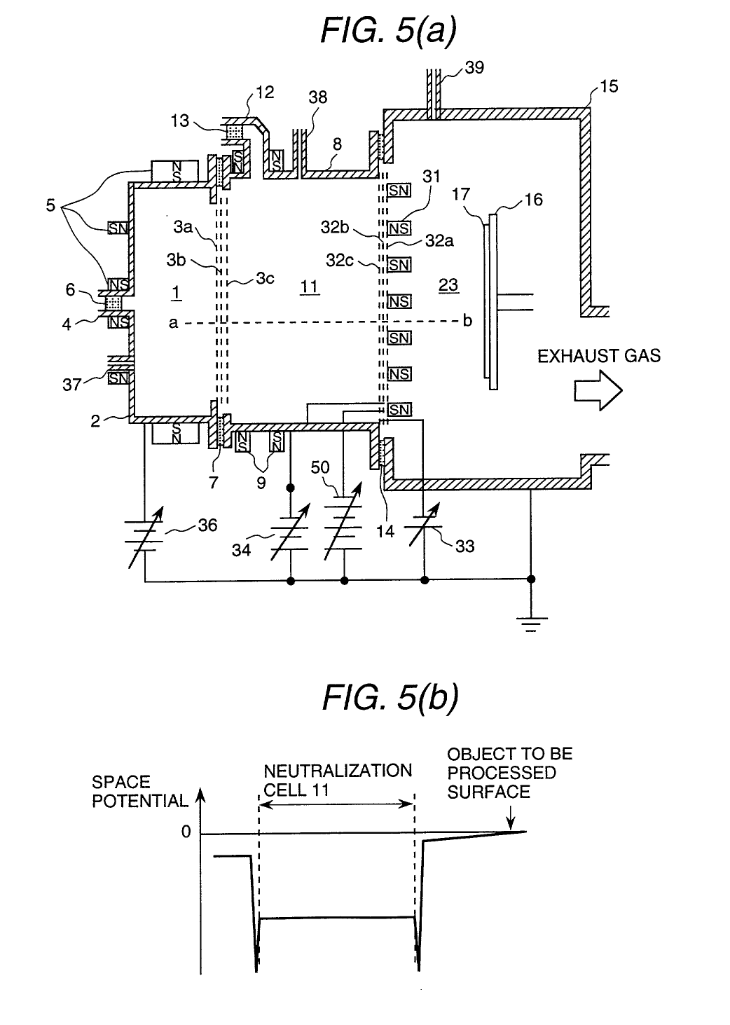

Next, a third embodiment according to the present invention will be explained referring to FIG. 5A and FIG. 5B. FIG. 5A is a vertical section of a neutral beam processing apparatus as a third embodiment of the invention, and FIG. 5B is a characteristic diagram of a space potential of the apparatus shown in FIG. 5A.

In this third embodiment according to the present invention, the charged particles remove means is constituted by the multi-aperture electrode 32a, 32b, and 32c, and a permanent magnet line 31. The permanent magnet line 31 is arranged in the process cell 23 and adjacent to this at a left side the multi-aperture electrode 32a and at a right side of this multi-aperture electrode 32a the multi-aperture electrode 32b and further at a right side of this multi-aperture electrode 32b the multi-aperture electrode 32c are arranged. Further, each of the multi-aperture electrode 32a, 32b, and 32c has a predetermined interval and the plural aperture having a predetermined size are formed. These multi-aperture electrode 32a, 32b, and 32c are connected to the direct current source 33, the direct current source 50 and the neutralization cell wall 8, respectively. To the generation cell wall 2 according to the direct current source 36, for example, the voltage having −100 V is applied, to the neutralization cell wall 8 and the multi-aperture electrode 32c, according to the direct current source 34, for example, the voltage having −700 V is applied, to the multi-aperture electrode 32b, according to the direct current source 50 the voltage having −900 V is applied, and to the multi-aperture electrode 32a, according to the direct current source 33 the voltage having −5 V degree is applied, accordingly two problems in the above stated first embodiment and the above stated second embodiment according to the present invention can be dissolved.

In concretely, in the above stated two embodiments according to the present invention, following two problems occur.

(1) In a case the gas in which the negative ion such as a halogen gas etc. is generated easily is used, in the neutralization cell 11 much negative ions occur, the discharged particles remove means in the above stated two embodiments, namely with respect to the neutralization cell wall 8 by the multi-aperture electrode 32 and the permanent magnet line 31 which are given the positive potential, since this negative ions are not removed, the negative ions enter into the process cell 23 and the surface of the object to be processed is irradiated.

Since the neutral beam is irradiated to the surface of the object 17 to be processed, a part of the secondary electrons becomes the ground potential and flows into the multi-aperture electrode 32, when the object 17 to be processed is an insulated material, there is a case that to the surface of the insulated material the positive potential lefts slightly and the surface of the object 17 to be processed is charged with 0.5—several V to the process cell wall 15.

On the other hand, in this embodiment according to the present invention, according to the direct current source 50, since the multi-aperture electrode 32b is given the negative potential than that of the neutralization cell wall 8, the negative ions which have generated according to this multi-aperture electrode 32b are repelled and the entering of the negative ions to the process cell 23 and the irradiation to the surface of the object to be processed can be prevented. However, since the neutral beam etc. are irradiated, the entering of the secondary electrons generated from the multi-aperture electrodes 32a and 32b can not be prevented.

On the other hand, in this embodiment according to the present invention, since the permanent magnet line 31 is arranged near to the process cell 23 than the multi-aperture electrodes 32a and 32b, the entering of the secondary electrons generated from the multi-aperture electrodes 32a and 32b can be prevented. As stated in above, in the neutralization processing apparatus of this embodiment according to the present invention, the charged particles can be removed surely from the neutral beam.

Further, according to this embodiment according to the present invention, since the multi-aperture electrodes 32 is given the slight negative potential (−5V) from the direct current source 33, the secondary electrons generated on the surface of the object 17 to be processed are repelled positively and are returned to the surface of the object 17 to be processed, the surface potential of the object 17 to be processed can be controlled to have about 0 V.

Further, since the plasma generation cell wall 2 which defines the ion source is established to have the negative potential (−100 V) according to the direct current source 36, even when the multi-aperture electrodes 32 is given the slight negative potential (−5V), the ion beam pulled out from the ion source can be repelled and removed completely.

In the foregoing embodiment, the neutralization cell wall 8 defining the neutralization cell 11 and also serving as a vacuum container has been described. However, the neutralization cell wall 8 does not always have to also serve as the vacuum vessel. An electrode disposed in a vacuum vessel may be used as the neutralization cell wall 8. As the means for generating a plasma in the neutralization cell 11, the means for generating a microwave plasma by using the permanent magnet line 9 and the waveguide 12 has been described. By using means for generating a high frequency plasma in the neutralization cell 11 or means for supplying electrons into the neutralization cell 11 by an electron gun or the like, a similar effect of flattening the space charge in the neutralization cell 11 in the invention as that of the foregoing embodiment can be produced.

As stated in above, according to the present invention, since the ions in charged particles included in a neutral beam are separated and removed from the neutral beam by a multi-aperture electrode, and the electrons are separated and removed from the neutral beam by a multi-pole magnetic field generated by a plurality of magnet lines. Consequently, the charged particles can be removed surely from the neutral beam.

Further, according to the present invention, the transmittance can be increased as compared with the technique of using a plurality of electrodes as the charged particle separating means, and the capacity of the neutral beam can be prevented from being decreased. Thus, the capacity of the neutral beam can be increased. Further, by increasing the number of magnet lines with the upsizing of the multi-aperture electrode, the diameter of the neutral beam can be enlarged. Further, since the positive potential to repel the ions is applied to the multi-aperture electrode, a wear due to collision with an ion beam can be avoided. By providing a conductive member as the charged particle separating means, the magnet line can be prevented from being irradiated with the ion beam, so that demagnetization caused by heating the magnet line can be prevented.

Further, according to the present invention, to the process cell wall for defining the process cell, the negative potential is given to the plasma generation cell wall for defining the ion source, the ion beam pulled out from the ion source can be prevented from centering to the process cell.

What is claimed is:

1. A neutral beam processing apparatus comprising:
an ion source;
an ion pulling-out electrode for pulling out ions from said ion source and generating an ion beam;
a neutralization cell for neutralizing and converting said ion beam pulled out by said ion pulling-out electrode in atmosphere of a neutral gas to a neutral beam;
charged particle separating means for separating charged particles from said neutral beam in said neutralization cell and allowing a neutral beam to pass; and
a process cell disposed adjacent to said neutralization cell, for housing an object to be processed on a propagation path of said neutral beam passed through said charged particle separating means,
wherein said charged particle separating means includes a multi-aperture electrode having a plurality of apertures through which said neutral beam passes, and a plurality of lines of magnets dispersively disposed adjacent to the multi-aperture electrode, for generating a multi-pole magnetic field near said multi-aperture electrode.

2. A neutral beam processing apparatus comprising:
an ion source;
an ion pulling-out electrode for pulling out ions from the ion source and generating an ion beam;
a neutralization cell for neutralizing and converting the ion beam pulled out by the ion pulling-out electrode in atmosphere of a neutral gas to a neutral beam;
charged particle separating means for separating charged particles from the neutral beam in the neutralization cell and allowing a neutral beam to pass; and
a process cell disposed adjacent to said neutralization cell, for housing an object to be processed on a propagation path of the neutral beam passed through said charged particle separating means,
wherein said charged particle separating means includes a multi-aperture electrode to which a positive potential with respect to a neutralization cell wall defining said neutralization cell is applied and which has a plurality of apertures through which said neutral beam passes, a plurality of lines of magnets dispersively disposed adjacent to the multi-aperture electrode, for generating a multi-pole magnetic field near said multi-aperture electrode, and a conductive member which is disposed in a magnetic pole portion of said multi-pole magnetic field in said neutralization cell and to which a negative potential with respect to said multi-aperture electrode is applied.

3. A neutral beam processing apparatus according to claim 2, wherein said plurality of magnet lines also serve as said conductive member.

4. A neutral beam processing apparatus according to claim 2, wherein said plurality of magnet lines are disposed so as to face said conductive member over said multi-aperture electrode.

5. A neutral beam processing apparatus according to any one of claims 2, 3, and 4, further comprising potential difference adjusting means for making a potential difference between a neutralization cell wall defining said neutralization cell and said conductive member.

6. A neutral beam processing apparatus according to any one of claims 1 to 5, further comprising electron replenishing means for supplying or generating electrons in said neutralization cell.

7. A neutral beam processing apparatus comprising:
an ion source;
an ion pulling-out electrode for pulling out ions from said ion source and generating an ion beam;
a neutralization cell for neutralizing and converting said ion beam pulled out by said ion pulling-out electrode in atmosphere of a neutral gas to a neutral beam;
charged particle separating means for separating charged particles from said neutral beam in said neutralization cell and allowing a neutral beam to pass; and
a process cell disposed adjacent to said neutralization cell, for housing an object to be processed on a propagation path of said neutral beam passed through said charged particle separating means,
wherein, to a process cell wall for defining said process cell, a mean for giving a negative potential to a plasma generation cell wall for defining said ion source is provided, and to said plasma generation cell wall, a mean for giving a negative potential to a neutralization cell wall for defining said neutralization cell is provided.

8. A neutral beam processing method comprising the steps of:
pulling out ions from an ion source to generate an ion beam;
converting the ion beam into a neutral beam in a neutralization cell;
separating and removing ions from charged particles existing in said neutral beam by disposing a multi-aperture electrode on an outlet side of said neutralization cell and by setting a predetermined potential;
generating a multi-pole magnetic field around said multi-aperture electrode by disposing a plurality of magnets near said multi-aperture electrode;
separating and removing electrons from charged particles existing in said neutral beam by the multi-pole magnetic field; and
irradiating an object to be processed in a process cell with the neutral beam passed through said multi-aperture electrode.

9. A neutral beam processing method comprising the steps of:
pulling out ions from an ion source and introducing the ions as an ion beam into a neutralization cell;
generating a multi-pole magnetic field around a multi-aperture electrode to which a positive potential with respect to a neutralization cell wall defining said neutralization cell is applied by disposing the multi-aperture electrode on an outlet side of said neutralization cell and disposing a plurality of magnets near said multi-aperture electrode;
converting said ion beam into a neutral beam in a space potential area which is flat in a wide range in said neutralization cell and is formed by disposing a conductive member to which a negative potential with respect to said multi-aperture electrode is applied in a magnetic pole portion of said multi-pole magnetic field in said neutralization cell;
separating and removing ions from charged particles existing in said neutral beam by said multi-aperture electrode;
separating and removing electrons from the charged particles by said multi-pole magnetic field; and
irradiating an object to be processed in a process cell with the neutral beam passed through said multi-aperture electrode.

10. A neutral beam processing method comprising the steps of:
pulling out ions from an ion source and introducing the ions as an ion beam into a neutralization cell;
converting said ion beam into a neutral beam in a neutralization cell;
removing charged particles from said neutral beam by a charged particle removing means; and
irradiating an object to be processed in a process cell with said neutral beam passed through said charged particle removing means,
wherein, to a process cell wall for defining said process cell, giving a negative potential to a plasma generation cell wall for defining said ion source, and further giving a negative potential to a neutralization cell wall for defining said neutral cell, thereby said ion beam pulled-out from said ion source is prevented from reaching to said process cell.
